(19) United States
(12) Patent Application Publication
(10) Pub. No.: US 2025/0321099 A1
(43) Pub. Date: Oct. 16, 2025

(54) MEASUREMENT METHOD AND METHOD FOR CONSTRUCTING STRUCTURE

(71) Applicant: NIKON CORPORATION, Tokyo (JP)

(72) Inventor: Takashi MIYAWAKI, Machida-shi (JP)

(73) Assignee: NIKON CORPORATION, Tokyo (JP)

(21) Appl. No.: 18/867,851

(22) PCT Filed: Jul. 5, 2023
(86) PCT No.: PCT/JP2023/024880

§ 371 Date: Nov. 21, 2024

(30) Foreign Application Priority Data
Jul. 8, 2022 (JP) 2022-110227

(51) Int. Cl. G01C 3/02; E04G 21/16; G01C 25/00; G01J 5/10

(52) U.S. Cl. CPC G01C 3/02; E04G 21/16; G01C 25/00; G01J 5/10

(57) ABSTRACT

A measurement method, with which effort involved in installation of a three-dimensional surveying instrument can be reduced, includes measuring positional information at a predetermined measurement point in an erected pillar (structural material) using a sensor device and the three-dimensional surveying instrument, and acquiring calibration information for the positional information measured by the sensor device on the basis of measurement results of both the sensor device and the three-dimensional surveying instrument (Step S104 and Step S106).

### TECHNICAL FIELD

The present invention relates to a measurement method and a method for constructing a structure, more specifically relates to a measurement method for a structural material of a structure set as an object and a method for constructing a structure utilizing the measurement method.

Priority is claimed on Japanese Patent Application No. 2022-110227, filed Jul. 8, 2022, the content of which is incorporated herein by reference.

### BACKGROUND ART

In the related art, when an architectural structure is constructed, there is a need to inspect whether construction materials constituting pillars, walls, and the like are assembled without any gradient or distortion. For example, a surveying instrument (for example, a total station or the like) constituting a part of an erection support system is used for measuring the accuracy of steel frame erection (for example, refer to Patent Document 1). However, measuring the accuracy of steel frame erection is performed a plurality of times for each steel frame pillar using a total station or the like during positional adjustment after temporary fixing (including misalignment adjustment and gradient adjustment), during remeasurement after beam insertion, after final tightening of pillar couplers, after welding of pillars, and the like.

However, as described above, measuring a gradient or the like of a pillar a plurality of times using a total station or the like is work requiring time and effort. In addition, at actual work sites, since there is a need to reuse the total station and the like, it is necessary to reinstall the total station and the like and reset a reference for every measurement. Moreover, there is concern that measurement which is repeated a plurality of times may cause a measurement error.

In this way, there is obviously room for improvement in a measurement method in the related art for a structural material using a surveying instrument such as a total station.

### CITATION LIST

### Patent Document

Patent Document 1: Japanese Patent No. 6433033

### SUMMARY OF INVENTION

### Technical Problem

According to a first aspect, a measurement method for a structural material of a structure as an object is provided. The measurement method includes measuring positional information of the structural material using a three-dimensional surveying instrument and a sensor device attached to the structural material, respectively, and acquiring calibration information for calibrating measurement information of the sensor device on the basis of measurement results of the positional information from both the three-dimensional surveying instrument and the sensor device.

According to a second aspect, a method for constructing a structure utilizing the measurement method according to the first aspect for a structural material of a structure under construction set as an object is provided. The method for constructing a structure includes measuring information of a tilt angle at a predetermined measurement point in a pillar to be erected set as the object using the sensor device and the three-dimensional surveying instrument, and acquiring the calibration information for causing information of a tilt angle measured by the sensor device to match information of a tilt angle measured by the three-dimensional surveying instrument on the basis of the measurement results.

According to a third aspect, a method for constructing a structure including pillars of a plurality of sections is provided. The method for constructing a structure includes setting an offset, on the basis of information of a tilt angle at a measurement point in an erected measurement target pillar measured by a sensor device which is attached to the measurement target pillar in advance during erection or immediately before erection of a pillar of an upper section on the measurement target pillar, to an erection target value for a pillar head of the pillar of the upper section.

According to a fourth aspect, a method for constructing a structure including pillars of a plurality of sections is provided. The method for constructing a structure includes measuring a temperature t in parallel with measurement of information of a tilt angle of a measurement target pillar by a sensor device at predetermined sampling intervals over a predetermined time prior to erection of a pillar of an upper section on the measurement target pillar after welding of the measurement target pillar to which the sensor device is attached has ended, obtaining a function f expressing information of the tilt angle acquired by the sensor device including the temperature t as a parameter on the basis of sampling data acquired through measurement, and setting an offset to an erection target value for a pillar head of the pillar of the upper section on the basis of the function f in which a reference temperature T is substituted for the parameter t.

### BRIEF DESCRIPTION OF DRAWINGS

FIG. 1 A view schematically showing an overall constitution of a measurement system according to an embodiment.

FIG. 2 A block diagram showing an example of a constitution of a sensor device in FIG. 1.

FIG. 3 A flowchart showing a flow of erection processing of an nth section pillar.

FIG. 4 A view showing erection pieces provided in each pillar and erection adjustment jigs attached to the erection pieces.

FIG. 5 An explanatory flowchart of erection measurement of a steel frame.

FIG. 6 A conceptual diagram showing a flow of erection measurement of a steel frame.

### DESCRIPTION OF EMBODIMENTS

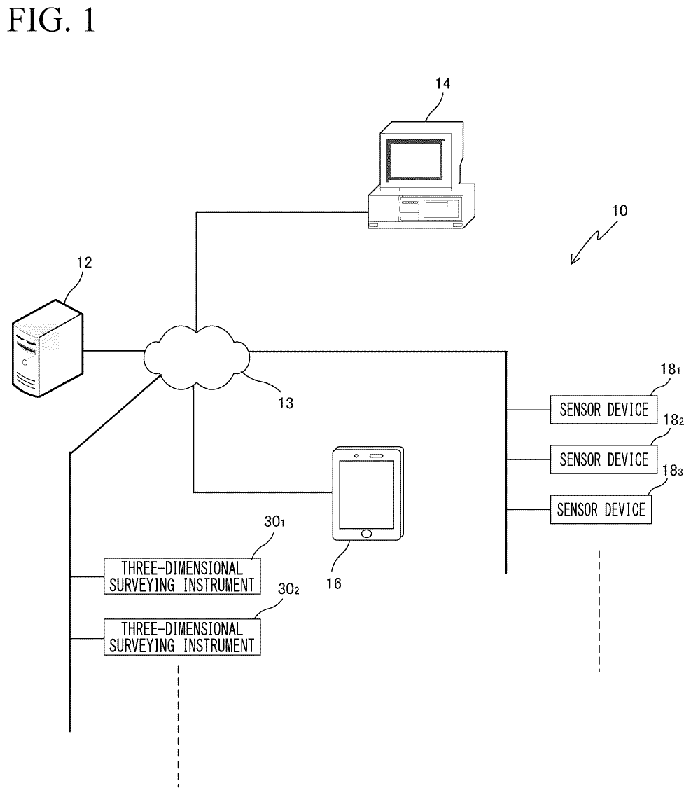

Hereinafter, an architectural structure will be taken as a structure, and an embodiment of a measurement method for a structural material thereof set as an object will be described on the basis of FIGS. 1 to 6. In the measurement method according to the present embodiment, a sensor device is used for a structural material of an architectural structure set as a measurement target.

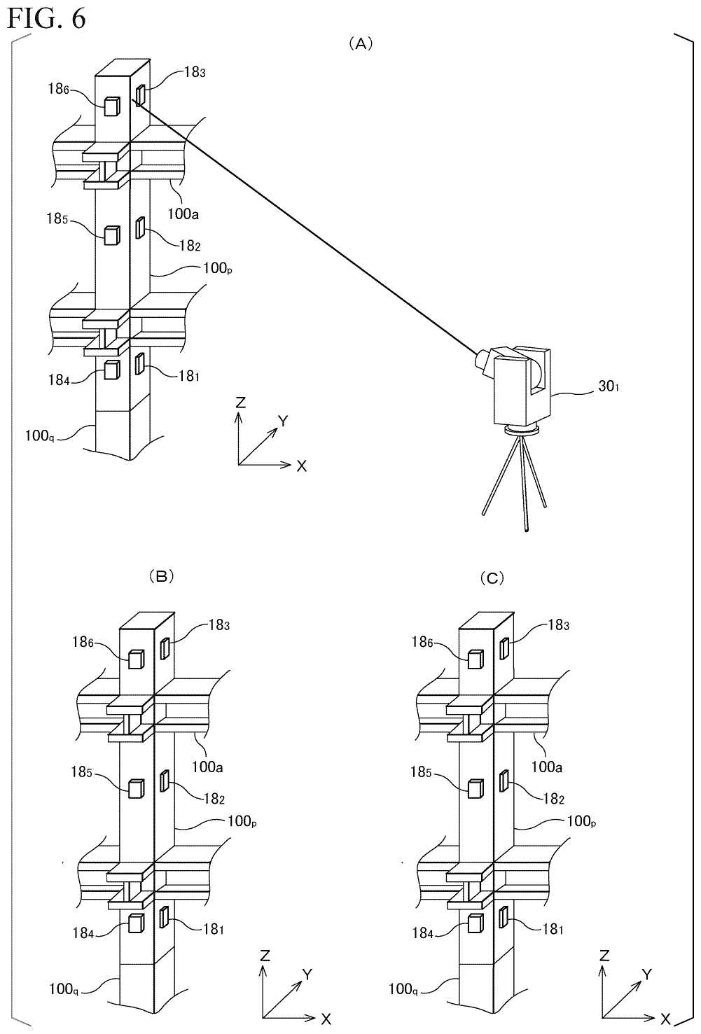

First of all, a measurement target of the sensor device, definitions of directions, and the like will be described. Hereinafter, as an example, a case in which a measurement target (object) for the sensor device is a steel frame pillar 100ₚ (refer to (A) part of FIG. 6, and the like) of one section constituting a building having a steel frame structure with a plurality of sections will be described. In a building having a steel frame structure, a steel frame pillar built on a foundation will be referred to as “a steel frame of a first section”, and a steel frame pillar built thereon will be referred to as “a steel frame of a second section”. The number representing the section (section number) increments as it goes upward thereafter. In addition, in the following description, as shown in FIG. 6(A) and the like, the vertical direction (direction of gravity) will be regarded as a Z axis direction. Within a plane orthogonal to the Z axis, a lateral direction within the paper in FIG. 6(A) will be regarded as an X axis direction. A direction orthogonal to the Z axis and the X axis will be regarded as a Y axis direction. Tilt (rotation) directions around the X axis, the Y axis, and the Z axis will be regarded as θx, θy, and θz directions, respectively.

FIG. 1 schematically shows an overall constitution of a measurement system 10 used in erection measurement of a steel frame structure. The measurement system 10 includes a server 12, a site side computer 14, a mobile terminal 16, a plurality of sensor devices 18ᵢ (i=1, 2, 3, and so on), and a plurality of three-dimensional surveying instruments 30ⱼ (j=1, 2, and so on), which are connected to each other via a wide area network (which will hereinafter be suitably abbreviated to a network) 13 such as the Internet. The plurality of sensor devices 18ᵢ are connected to the network 13 via communication lines, for example, a wireless LAN. FIG. 1 representatively shows three sensor devices 18₁ to 18₃ of the plurality of sensor devices 18ᵢ. Similarly, the plurality of three-dimensional surveying instruments 30ⱼ are connected to the network 13 via communication lines, for example, a wireless LAN. FIG. 1 representatively shows two three-dimensional surveying instruments 30₁ and 30₂ of the plurality of three-dimensional surveying instruments 30ⱼ.

All the communication lines may be wireless, but at least some may be wired. The present embodiment employs a constitution in which outputs of the plurality of sensor devices 18ᵢ and outputs of the plurality of three-dimensional surveying instruments 30ⱼ are provided to the server 12 via communication lines and the network 13. Hereinafter, one network constituted to include the network 13 and all the communication lines respectively connecting the server 12, the site side computer 14, the mobile terminal 16, the plurality of sensor devices 18ᵢ, and the plurality of three-dimensional surveying instruments 30ⱼ to the network 13 is indicated as the network 13 using the same reference sign as the wide area network 13.

In the present embodiment, a generally used server computer is used as the server 12, but a cloud (computer) may be used.

In the present embodiment, the site side computer 14 is a generally used computer. The site side computer 14 includes operation units such as a keyboard and a mouse, and a screen such as a liquid crystal display. The site side computer 14 performs data communication with the server 12 and the mobile terminal 16 via the network 13 in response to an instruction input by a work site supervisor or other managers via the operation units. The site side computer 14 may not be provided and may be replaced with the mobile terminal 16. In this case, a manager (a work site supervisor or the like) uses the mobile terminal 16 to perform data communication with the server 12 or data communication with other mobile terminals 16 carried by on-site workers via the network 13. The mobile terminals 16 are carried by workers at a construction site. For example, the mobile terminals 16 are smartphones or tablet PCs.

A measurement instruction and the like with respect to the sensor devices 18ᵢ are given from any of the mobile terminals 16, the site side computer 14, and the server 12 via the network 13, and output data from the sensor devices 18 is provided to the server 12 via the network 13. In addition, necessary computation processing and the like using output data from the sensor devices 18; are performed by the server 12, and necessary information is provided from the server 12 to the mobile terminal 16 in response to an inquiry from the mobile terminal 16 or in accordance with a predetermined program.

As an example, a total station of a type which does not require a prism or other targets and is capable of performing three-dimensional measurement is used as the three-dimensional surveying instrument 303. The three-dimensional surveying instrument 30ⱼ emits light to a target point (measurement position) and receives reflected light (return light) thereof so that one machine can measure tilt angles (vertical angles and horizontal angles) and distances at the same time. The three-dimensional surveying instrument may be a 3D laser scanner or the like and may be any measurement device as long as it can measure information of the angle and the distance regardless of the method. The term “surveying” used in this specification has a broad meaning synonymous with simple measurement. The three-dimensional surveying instrument described in this specification can also be rephrased as a three-dimensional measurement device or a three-dimensional measurement instrument.

Measurement instructions and the like with respect to the three-dimensional surveying instrument 30ⱼ are given from any of the mobile terminals 16, the site side computer 14, and the server 12 via the network 13, and output data from the three-dimensional surveying instrument 30ⱼ is provided to the server 12 via the network 13. In addition, necessary computation processing and the like using output data from the three-dimensional surveying instrument 30ⱼ are performed by the server 12, and necessary information is provided from the server 12 to the mobile terminal 16 in response to an inquiry from the mobile terminal 16 or in accordance with a predetermined program.

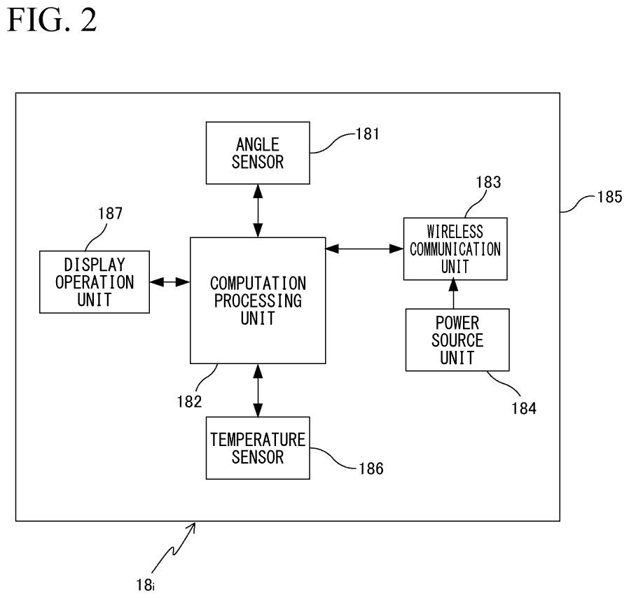

Here, a specific constitution and the like of the sensor device 18ᵢ will be described. As shown in FIG. 2, each of the sensor devices 18ᵢ includes an angle sensor 181, a computation processing unit 182, a wireless communication unit 183, a power source unit 184 (constituted of a battery, for example), a temperature sensor 186, a display operation unit 187, and a waterproof casing 185 which internally accommodates these. The power source unit 184 has a constitution in which power supply to each unit can be turned on and off by a remote operation from the outside (for example, the server 12, the site side computer 14, the mobile terminal 16, or the like). Without being limited to this, a power source switch which can be manually turned on and off may be provided in the casing 185.

In the present embodiment, as an example, a three-dimensional microelectromechanical system (3D MEMS) tilt angle sensor is used as the angle sensor 181. The 3D MEMS tilt angle sensor is a precision tilt sensor produced using 3D MEMS technology. Extremely little power is required for the 3D MEMS tilt angle sensor, which is a power consumption in a microampere range and this is suitable for wireless application. An angle sensor, into which two MEMS acceleration sensors having symmetrical output characteristics and an ASIC are built, is used as the angle sensor 181 and outputs information of tilt angles (α, β, and γ) in three directions (θx direction, θy direction, and θz direction), with respect to, as a reference, the direction of gravity (Z axis direction), for example. The tilt angles are tilt angles of normal vectors on a measurement surface at measurement points. Therefore, a shift amount (lateral deviation) of the measurement point can also be obtained from the tilt angles by geometric computation. The angle sensor is not limited to a 3D MEMS tilt angle sensor, and other kinds of three-dimensional tilt angle sensors may be used. In addition, the angle sensor is not limited to a three-dimensional tilt angle sensor, and a two-dimensional tilt angle sensor or a one-dimensional tilt angle sensor may be used depending on the measurement object. At this time, a two-dimensional tilt angle sensor and a one-dimensional tilt angle sensor may be used in combination, or a plurality of two-dimensional tilt angle sensors or one-dimensional tilt angle sensors may be used in combination.

For example, the computation processing unit 182 is constituted of a microcontroller unit (MCU) and has a CPU (not shown), a memory device, an input/output circuit, and a timer circuit. The computation processing unit 182 executes a processing algorithm stipulated by a program stored inside the memory device. The computation processing unit 182 controls the sensor devices 18ᵢ in their entirety. The ASIC built into the angle sensor 181 may have the function of the computation processing unit 182 without providing the computation processing unit 182.

In the present embodiment, the wireless communication unit 183 functions as a Wi-Fi communication (wireless LAN communication) unit. The sensor devices 18ᵢ can perform wireless LAN communication with the server 12 and other instruments connected to the network 13 via the network 13. A wired communication unit may be provided in place of a part of the wireless communication unit 183.

As an example, a MEMS non-contact temperature sensor is used as the temperature sensor 186. The MEMS non-contact temperature sensor measures the temperature on a surface of an object in a non-contact manner by receiving radiant heat energy from the object with a thermopile element. Power required for the MEMS non-contact temperature sensor is extremely low, which is power consumption in a microampere range. The temperature sensor is not limited to a MEMS non-contact temperature sensor, and other kinds of temperature sensors may be used.

For example, the display operation unit 187 is constituted of a so-called touch panel and allows inputting, displaying, and the like of data using a human finger or a touch pen.

Although illustration is omitted, a plurality of recessed portions are formed in a bottom wall (a wall on a rear surface side) of the casing 185, and permanent magnets are embedded in the respective recessed portions. For this reason, the sensor devices 18ᵢ can be attached to an object such as a steel frame with a single touch utilizing magnetic forces of the permanent magnets. In addition, a plurality of open recessed portions for inserting a tool during detachment are provided on side surfaces of the bottom wall of the casing 185. For this reason, the sensor devices 18ᵢ can be detached from an object in a relatively short time. Inside the casing 185, a magnetic shielding member is disposed at a position close to the rear surface so that an influence of magnetic forces of the permanent magnets on components therein is effectively blocked. A method for fixing the sensor devices to an object is not limited to magnetic forces, and other fixing methods may be used. For example, a mechanical fixing method or an adhesion method using an adhesive, a double-sided tape, or the like may be used. In this case, an object to which the sensor devices are fixed is not limited to a steel frame (that is, the fixing method does not depend on the material of an object).

Measurement data (sensor data) such as a tilt angle and a temperature is output from each of the sensor devices 18ᵢ constituted as described above to the outside via the wireless communication unit 183. However, this sensor data includes an ID that is identification information of the sensor device. For example, the ID is linked to information output from the angle sensor 181 and the temperature sensor 186 by the computation processing unit 182. Therefore, the server 12 or the like receiving the sensor data via the network 13 can reliably identify which sensor device the sensor data comes from.

In addition, the sensor devices 18ᵢ are not limited to the constitution of the present embodiment, and all the angle sensor 181, the wireless communication unit 183, the temperature sensor 186, and the like may not be integrally constituted. For example, the angle sensor 181 and/or the temperature sensor 186 may be connected to other units through wireless or wired communication lines and may be constituted such that data is output from the angle sensor 181 and/or the temperature sensor 186 and power is supplied to the angle sensor 181 and/or the temperature sensor 186 via the communication lines.

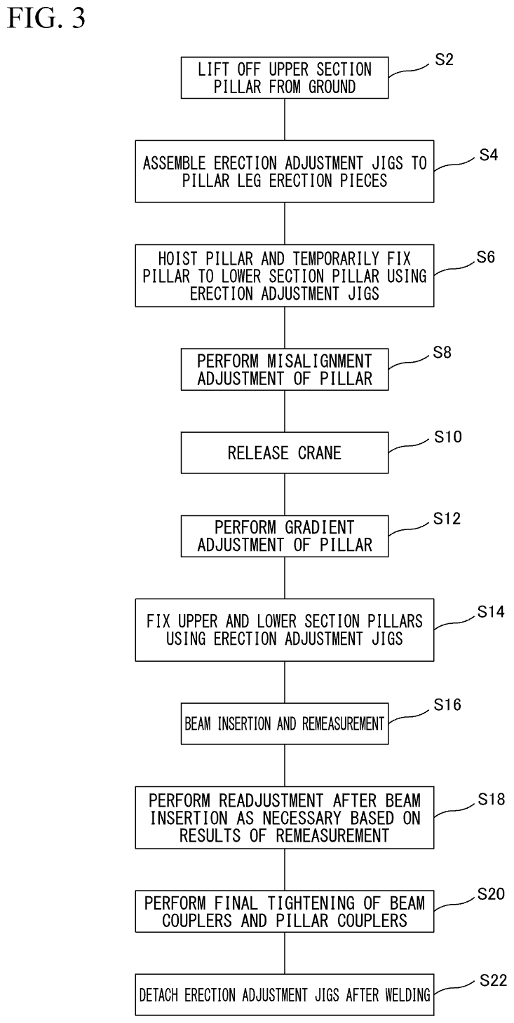

Next, a method for erecting a steel frame structure (which will hereinafter be abbreviated to erection) will be described along the flowchart in FIG. 3 focusing on erection of a steel frame of an n(≥2)th section (which will hereinafter be suitably indicated as an nth section pillar). FIG. 3 shows a flow of processing of erection of the nth section pillar. As a precondition for starting erection of the nth section pillar, erection of an (n−1)th section pillar should have ended.

First, in Step S2, the upper section pillar (here, the nth section pillar) 100ₚ is hoisted and lifted off from the ground by a crane.

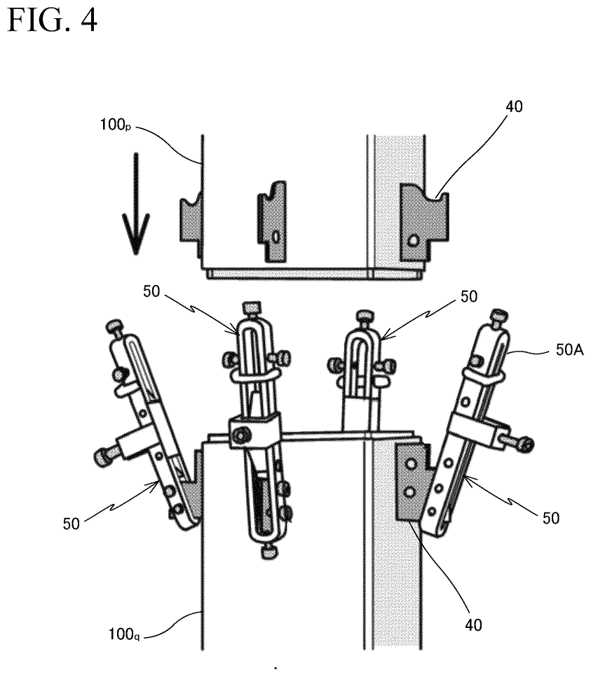

In the subsequent Step S4, erection adjustment jigs are assembled to pillar head erection pieces of the lower section pillar (here, the (n−1)th section pillar) 100_{q} (or pillar leg erection pieces of the upper section pillar). As shown in FIG. 4 as an example, each pillar 100 (in FIG. 4, 100ₚ or 100_{q}) is constituted of a steel pipe (a steel frame for a pillar) having a rectangular cross-sectional shape, and erection pieces 40 are projectingly provided in a pillar leg and a pillar head of the steel frame for a pillar, respectively. The erection pieces 40 are respectively welded on four surfaces orthogonal to each other in the steel frame for a pillar having a rectangular cross-sectional shape. Each of the erection pieces 40 is orthogonal to each of the surfaces of the pillar 100 and extends in an upward-downward direction. Four erection adjustment jigs 50 are respectively assembled to the erection pieces 40 on four surfaces of the lower section pillar 100_{q}. The erection adjustment jigs 50 used in the present embodiment are assembled to joint portions of the pillar for pillar fall prevention, misalignment adjustment, gradient adjustment, and the like. For example, Japanese Unexamined Patent Application, First Publication No. 2001-355340 discloses a detailed constitution of a steel frame pillar tilt adjustment device having a constitution similar to that of the erection adjustment jig 50.

The erection adjustment jigs 50 each include a main body frame 50A which is a coupling body coupling the erection piece 40 of the pillar leg of the upper section pillar 100ₚ and the erection piece 40 of the pillar head of the lower section pillar 100_{q}, a plurality of bolts which are attached to the main body frame 50A and realize the foregoing various adjustment functions (specifically, fall prevention bolts, misalignment adjustment bolts, gradient adjustment bolts, or the like), and the like.

Returning to FIG. 3, in the subsequent Step S6, the upper section pillar 100ₚ is hoisted by a crane and is temporarily fixed to the lower section pillar 100_{q} using the erection adjustment jigs 50. Specifically, the upper section pillar 100ₚ is hoisted, and in a state in which the four erection adjustment jigs 50 attached to the erection pieces 40 of the pillar head of the lower section pillar 100_{q} (or the erection pieces 40 of the pillar leg of the upper section pillar 100ₚ) are opened (refer to FIG. 4), the upper section pillar 100ₚ is placed on the lower section pillar 100_{q}. The erection pieces 40 of the pillar leg of the upper section pillar 100ₚ (or the pillar head of the lower section pillar 100_{q}) are respectively wrapped by the main body frames 50A of the four erection adjustment jigs 50, and four sets of the erection pieces 40 projectingly provided in each of the pillar leg of the upper section pillar 100ₚ and the pillar head of the lower section pillar 100_{q} are coupled to each other using the erection adjustment jigs 50.

In the subsequent Step S8, misalignment adjustment of the pillar is performed. Misalignment indicates a positional deviation within a horizontal plane between the pillar head of the lower section pillar 100_{q} and the pillar leg of the upper section pillar 100ₚ, and this misalignment adjustment is performed by adjusting positions of the upper section pillar in the X axis direction and the Y axis direction using the four erection adjustment jigs 50 such that the upper section pillar 100ₚ and the lower section pillar 100_{q} appear to be a single pillar in a state in which the upper section pillar 100ₚ is placed on the lower section pillar 100_{q} while the upper section pillar 100ₚ is hoisted by a crane.

After this, the crane is released (Step S10). When the weight of the pillar is lighter than a predetermined value, the crane can also be open before misalignment adjustment is performed.

In the subsequent Step S12, gradient adjustment (which will also be referred to as re-erection) of the pillar is performed. This gradient adjustment is performed by adjusting the tilt angles of the upper section pillar using the four erection adjustment jigs 50 such that tilt errors with respect to the vertical axis (Z axis) fall within a predetermined allowable value while information of the tilt angles of the upper section pillar is measured. Here, erection denotes the degree of verticality of the pillar.

In the subsequent Step S14, the upper section pillar and the lower section pillar are fixed using the four erection adjustment jigs 50. This fixing is performed by temporarily tightening (slightly tightening) each of the adjustment bolts included in the four erection adjustment jigs 50 using a dedicated tool.

The foregoing processing from Steps S2 to S14 is performed in sequence (or partially in parallel) for a plurality of upper section pillars (nth section pillars).

Further, in the subsequent Step S16, beam insertion and remeasurement after beam insertion are performed. Here, beam insertion generally indicates that a steel frame for a beam is disposed between two pillars and both ends of the steel frame for a beam are respectively coupled to the two pillars. In the present embodiment, regarding a steel frame for a beam (steel frame beam), a beam having a pair of beam end members 100a which are positioned at both end portions of the steel frame beam and joined to the pillar 100 (refer to FIG. 6(A)), and a beam center member (not shown) of which one end and the other end are joined to the pair of beam end members 100a is used. Therefore, in the present embodiment, beam insertion denotes that a center member is disposed between two beam end members which are respectively joined to two pillars and the center member and the beam end members on both sides are respectively coupled to each other by beam couplers. However, due to a manufacturing error which is inevitably present in a steel frame for a beam, a horizontal force acting on the pillar coupled to both ends of the steel frame for a beam during beam insertion may cause change in tilt angles of the pillar before the beam insertion. In order to confirm this change, there is a need to remeasure information of the foregoing tilt angles after the beam insertion.

In the subsequent Step S18, based on results of the remeasurement, readjustment after beam insertion is performed as necessary. Readjustment after beam insertion may include pillar misalignment adjustment, pillar gradient adjustment, and pillar level adjustment. These are performed by readjusting the four erection adjustment jigs 50. However, misalignment of the pillar which cannot be sufficiently adjusted by readjusting the erection adjustment jigs may be adjusted using other jigs for adjustment. In addition, for example, in readjustment of the pillar gradient, the tilt angles of the pillar are adjusted while the information of the tilt angles of the pillar is measured, and it is confirmed that the tilt errors fall within an allowable value set in advance.

In the subsequent Step S20, final tightening of beam couplers and pillar couplers is performed. The final tightening of the beam couplers is performed by fastening high-strength bolts in coupler portions of the pillar and the beam, and the final tightening of the pillar couplers is performed by performing the final tightening of respective adjustment bolts in the four erection adjustment jigs 50. After this final tightening, measurement of information of the tilt angles of the upper section pillar 100ₚ (which will hereinafter be suitably indicated as tilt angle measurement) is performed, and it is confirmed that the tilt errors fall within the allowable value set in advance. Here, in a stage of the foregoing readjustment (Step S18), since the tilt errors are adjusted within the allowable value, the tilt errors of the pillar normally fall within the allowable value. For instance, when tilt errors of the pillar do not fall within the allowable value, the tilt angles of the pillar are adjusted again, and then it is confirmed that the tilt errors are within the allowable value. Since the management allowable difference in pillar gradient is set to 1/1000 of the pillar length and 10 mm or smaller, the allowable value need only be set to satisfy this and has a certain range.

After an elapse of a predetermined time, after the upper section pillar 100ₚ is welded to the lower section pillar 100_{q}, the four erection adjustment jigs are detached (Step S22). Thereafter, cutting of the erection pieces is performed. After welding as well, the tilt angles of the upper section pillar 100ₚ are measured for the purpose of confirming that the tilt angles of the upper section pillar fall within the allowable value. Here, since it has been confirmed in the foregoing Step S20 that the tilt errors are within the allowable value, the tilt errors of the pillar normally fall within the allowable value. However, since a certain period of time elapses before welding starts after the final tightening has ended, there may be a case in which the tilt errors of the upper section pillar 100ₚ do not fall within the allowable value. In such a case, since welding has ended, it is difficult to perform readjustment any longer, but measurement results of the tilt angles can be utilized. For example, on the basis of the measurement results of the tilt angles, it is possible to set an offset for canceling (an influence of) the tilt errors to an erection target value of the pillar head of the upper section pillar (here, the (n+1)th section pillar). The tilt angles of the upper section pillar may be measured immediately before welding to confirm whether or not the tilt errors are within the allowable value, and if they are out of the allowable value, welding may be performed after readjustment.

Next, erection measurement of a steel frame using sensor devices and performed during erection of the nth section pillar will be described. The sensor devices 18 are used in measurement of the tilt angles of the upper section pillar in each of Step S12, Step S16, and Step S20 described above, measurement for confirming the tilt angles of the upper section pillar after welding (Step S22), and the like.

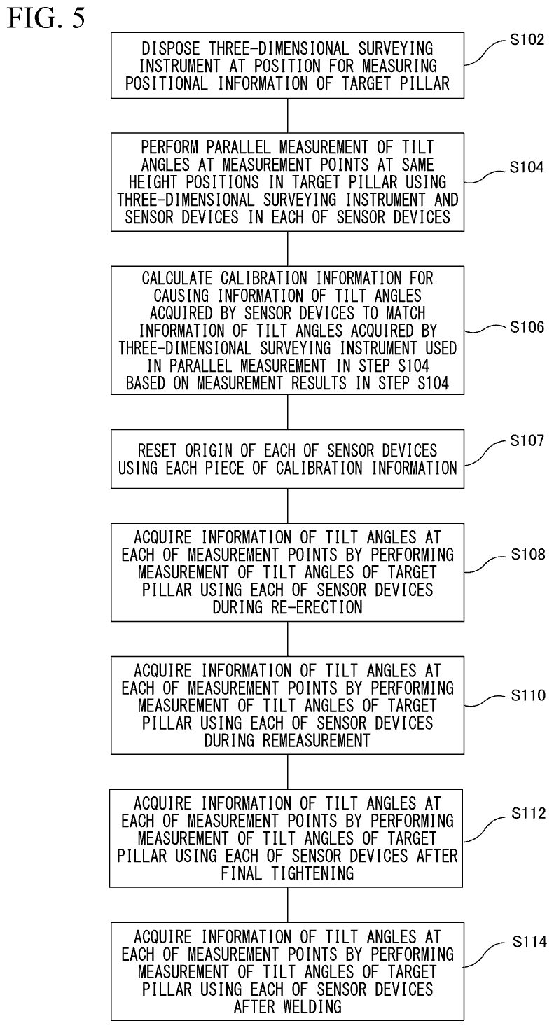

FIG. 5 shows a flowchart of erection measurement of a steel frame. In addition, FIGS. 6(A) to 6(C) show conceptual diagrams showing a flow of erection measurement of a steel frame. FIGS. 6(A) to 6(C) show the nth section pillar that is a measurement target (which will hereinafter be referred to as a target pillar) 100ₚ together with the lower section pillar 100_{q}. The sensor devices 18₁ to 18₆ are attached to the target pillar 100ₚ in advance (immediately after the target pillar is temporarily fixed in the foregoing Step S6 or before the target pillar is lifted off from the ground) at a predetermined number (as an example, three locations on each of the positive X side surface and the negative Y side surface, that is, six locations in total) of attachment positions. Marks are placed at the attachment positions in advance, and the mark positions are set in advance such that they match the measurement positions of the target pillar managed by the server 12 after erection of the target pillar. Here, the sensor device 18₁ and the sensor device 18₄, the sensor device 18₂ and the sensor device 18₅, and the sensor device 18₃ and the sensor device 18₆ are attached at positions at the same height. Here, the sensor devices 18ᵢ may be attached at least at two arbitrary attachment positions (mark positions) only as long as two locations in the pillar head portion. Alternatively, the mark positions may be provided in seven or more locations.

Hereinafter, the flowchart in FIG. 5 will be described suitably with reference to other diagrams.

First, in Step S102, the three-dimensional surveying instrument 30ⱼ is installed at a position where positional information (in this case, information of the tilt angles) of the target pillar 100ₚ can be measured. FIG. 6(A) shows a state after the three-dimensional surveying instrument 30₁ is installed.

In the subsequent Step S104, parallel measurement of the tilt angles at the measurement points at the same height positions in the target pillar 100ₚ is performed by the three-dimensional surveying instrument 30ⱼ and the sensor devices 18ᵢ in each of the sensor devices 18ᵢ (i=1 to 6). At least a part of parallel measurement of the sensor devices 18ᵢ and the three-dimensional surveying instrument 303 need only be performed in parallel in terms of time. FIG. 6(A) shows a condition of parallel measurement of the tilt angles of the target pillar 100ₚ by the three-dimensional surveying instrument 30₁ and the sensor device 18₃ as an example, and other sensor devices 18ᵢ (i=1, 2) also perform parallel measurement with the three-dimensional surveying instrument 30₁ in a similar manner. For parallel measurement with the sensor devices 18ᵢ (i=4, 5, 6) attached to the negative Y side surface, it is more favorable that another three-dimensional surveying instrument 30ⱼ (for example, the three-dimensional surveying instrument 30₂) be installed at an appropriate position in Step S102. In such a case, parallel measurement of the tilt angles of the target pillar 100ₚ using the three-dimensional surveying instrument 30₁ and the sensor device 18₃ (18₂, 18₁) and the three-dimensional surveying instrument 30₂ and parallel measurement of the tilt angles of the target pillar 100ₚ using the sensor device 18₆ (18₅, 18₄) can be performed in parallel. In Step S104, at least a part of measurement of the tilt angles at the measurement points at the same height positions in the target pillar 100 by the three-dimensional surveying instrument 30ⱼ and the sensor devices 18ᵢ does not necessarily have to be performed in parallel in terms of time. That is, after measurement is performed by the three-dimensional surveying instrument 30ⱼ and one of the sensor devices 18ᵢ, measurement may be performed by another sensor device after an elapse of a short period of time to the extent that measurement values scarcely change.

In the subsequent Step S106, on the basis of the measurement results in Step S104, calibration information for causing the information of the tilt angles acquired by the sensor devices 18ᵢ to match the information of the tilt angles acquired by the three-dimensional surveying instrument 30ⱼ used in parallel measurement in Step S104 is obtained (calculated).

For example, calibration information (δθy, δθz) in the θy direction and the θz direction is obtained on the basis of tilt angles (β₁, γ₁) acquired by the three-dimensional surveying instrument 30₁ and tilt angles (β₂, γ₂) acquired by the sensor device 18₃ (18₂, 18₁).

$$δ θ y = {β}_{2} - {β}_{1}$$

$$δ θ z = {γ}_{2} - {γ}_{1}$$

In addition, for example, calibration information δθx in the θx direction is obtained on the basis of a tilt angle α₁ in the θx direction acquired by the three-dimensional surveying instrument 30₂ and a tilt angle α₂ in the θx direction acquired by the sensor device 18₆ (18₅, 18₄).

$$δ θ x = {α}_{2} - {α}_{1}$$

Calculation of the calibration information in Step S106 is performed in each of the sensor devices 18ᵢ based on the tilt angles acquired by the three-dimensional surveying instrument 30ⱼ used in parallel measurement.

However, the calibration information in the θz direction may be obtained on the basis of the tilt angle in the θz direction acquired by the three-dimensional surveying instrument 30₂ and the tilt angle in the θz direction acquired by the sensor device 18₆ (18₅, 18₄). That is, it is sufficient to obtain the calibration information in the θz direction for only one of the sensor devices attached at the same height positions in the pillar.

Here, the tilt angle in the θx direction in the sensor device 18₃ (18₂, 18₁) is not taken into account because the sensor device 18₆ (18₅, 18₄) is provided at the same height position. Therefore, when only the three sensor devices 18₃, 18₂, and 18₁ are attached to the pillar, measurement of the tilt angles in the θx direction in the pillar may be executed by the sensor device 18₃ (18₂, 18₁) in parallel with measurement of the tilt angles on the negative Y side surface in the pillar by the three-dimensional surveying instrument 30₂. In this case, the calibration information δθx in the sensor device 18₃ (18₂, 18₁) may be obtained by the three-dimensional surveying instrument 30₂ using the tilt angle α₁ at the measurement point at the same height position. Consequently, it is sufficient to prepare three sensor devices for each target pillar.

Next, resetting an origin of resetting a measurement origin of each of the sensor devices 18ᵢ is performed using each piece of the calculated calibration information such that it matches the measurement origin of the three-dimensional surveying instrument 303 used in parallel measurement (Step S107). In the present embodiment, the calibration information is simply an offset, but it is not limited to this, and the calibration information may be managed as a correction coefficient.

Without resetting the origin, the information of the tilt angles at each of the measurement points measured by each of the sensor devices 18; may be converted into the information of the tilt angles acquired by the three-dimensional surveying instrument 30ⱼ used in parallel measurement using the calibration information every time measurement is performed. In this specification, “parallel” is not limited to the case in which two kinds of operations (for example, measurement operations) are performed almost at the same time and includes a case in which at least a part of them is performed with a time lag, and a case in which two kinds of operations are consecutively performed (a case in which an end time of one operation almost matches a start time of the other operation).

In any case, after calculation of the calibration information, it is possible to obtain information of the tilt angles which are substantially equivalent to the information of the tilt angles at the measurement points in the target pillar 100ₚ measured using the three-dimensional surveying instrument 30ⱼ by measuring the tilt angles at the measurement points in the target pillar 100ₚ using the sensor devices 18ᵢ.

After calculation of the calibration information, each of the three-dimensional surveying instruments 30ⱼ can be used for different measurement work.

In the subsequent Step S108, during re-erection, the information of the tilt angles at each of the measurement points is acquired by performing measurement of the tilt angles of the target pillar 100ₚ using each of the sensor devices 18ᵢ and acquiring sensor data output from each of the sensor devices 18ᵢ. Here, in Step S12 described above, re-erection is performed by adjusting the erection adjustment jigs 50 on the basis of the information of the tilt angles acquired in measurement by the sensor devices 18ᵢ.

Thereafter, remeasurement is performed after beam insertion described above (Step S16). During this remeasurement, in Step S110, the sensor data output from each of the sensor devices 18ᵢ is acquired by performing measurement of the tilt angles of the target pillar 100ₚ using each of the sensor devices 18ᵢ, and the information of the tilt angles at each of the measurement points is acquired.

Thereafter, necessary readjustment and final tightening of the beam couplers and the pillar couplers are performed (Steps S18 and S20). After the final tightening, in Step S112, the sensor data output from each of the sensor devices 18ᵢ is acquired by performing measurement of the tilt angles of the target pillar 100ₚ using each of the sensor devices 18ᵢ, and the information of the tilt angles at each of the measurement points is acquired. FIG. 6(B) shows a state in which measurement of the tilt angles of the target pillar 100ₚ is performed by each of the sensor devices 18 after final tightening.

Thereafter, after welding (refer to Step S22) of the target pillar 100ₚ is performed, in Step S114, the sensor data output from each of the sensor devices 18ᵢ is acquired by performing measurement of the tilt angles of the target pillar 100ₚ using each of the sensor devices 18ᵢ, and the information of the tilt angles at each of the measurement points is acquired. FIG. 6(C) shows a state in which measurement of the tilt angles of the target pillar 100ₚ is performed by each of the sensor devices 18ᵢ after welding.

Here, when these measurement results in Step S114 (or the tilt errors obtained on the basis thereof) do not fall within the allowable value for some reason, it is difficult to perform readjustment any longer as described above.

Under such circumstances, a case in which an upper section pillar ((n+1)th section pillar) is further added onto the target pillar 100ₚ (nth section pillar) is considered. In this case, if the sensor devices 18ᵢ remain in a state of being attached to the lower section pillar, that is, the target pillar 100ₚ, at the time when the upper section pillar is stacked on the target pillar 100ₚ, on the basis of the information of the tilt angles at each of the measurement points in the target pillar 100ₚ measured in real time by the sensor devices 18ᵢ, an offset can be set at an erection target position for the pillar head of the upper section pillar by performing predetermined computation (for example, geometric computation, computation using a predetermined function, or the like) so as to obtain the amount of positional deviation from a reference position (set on the basis of the results of remeasurement described above) in the X axis direction and the Y axis direction (or the directions of north, south, east, and west) for the pillar head of the target pillar 100ₚ.

On the other hand, when the sensor devices 18ᵢ are used for measurement of the upper section pillar on the target pillar 100ₚ, or the like, before the upper section pillar is stacked on the target pillar 100ₚ, it may be necessary to detach the sensor devices 18ᵢ from the target pillar 100ₚ. In such a case, the position of the pillar head of the target pillar 100ₚ, the positional deviation, and the like cannot be measured in real time. However, even in this case, when the sensor devices 18; are detached from the target pillar 100ₚ immediately before measurement of the upper section pillar starts, the information of the tilt angles at the measurement point of each of the sensor devices immediately before detachment is used, and therefore an offset of the erection target position for the pillar head of the upper section pillar can be set similarly to the case of the foregoing real-time measurement.

On the other hand, when the sensor devices 18 are detached early from the target pillar 100ₚ (lower section pillar), the foregoing immediately preceding measurement information cannot be obtained. For this reason, when the sensor devices 18ᵢ are detached early from the target pillar 100ₚ, the foregoing offset cannot be set any longer directly using the measurement information of the sensor devices 18ᵢ.

Hence, as a second best solution, a method of estimating the tilt angles of the lower section pillar virtually measured using the sensor devices 18ᵢ from other physical quantities that are relevant to the tilt angles and the like of the steel frame pillar is considered. As a result confirmed by the inventor through an experiment, it has been found that the amount of change in tilt of the steel frame pillar is significantly related to temperature fluctuation.

Hence, the relationship between the measurement values of the tilt angles at the measurement points measured by the sensor devices 18ᵢ and the temperature (t) is subjected to functionization, in other words, the measurement values are expressed as a function f(t) of the temperature. Further, the measurement information of the sensor devices 18ᵢ is calculated using the function f(t). Specifically, the following applies.

Using each of the sensor devices 18ᵢ, the measurement data of the tilt angle at each of the measurement points in the target pillar 100ₚ and the measurement data of the temperatures at the time of the measurement are taken at predetermined sampling intervals for a predetermined time (for example, 24 hours) before the sensor devices 18ᵢ are detached, and a plurality of pieces of the taken sampling data are plotted on a two-dimensional coordinate system with temperature on the horizontal axis and tilt angle on the vertical axis. Further, the function f(t) having the temperature t as a parameter obtained by function fitting of the plotted points is obtained for each of (measurement points of) the sensor devices. Here, as a reference temperature T, for example, the average value of the temperature (average temperature) during the foregoing predetermined time is also obtained.

Further, the reference temperature T is substituted for the foregoing function f(t) in each of the sensor devices to estimate the tilt angle of the target pillar 100ₚ (lower section pillar) at each of the measurement points, and using results of the estimation, similarly to that described above, an offset is set at the erection target position for the pillar head of the upper section pillar similarly to the case of the foregoing real-time measurement.

Here, the foregoing offset is actually taken into consideration at the time of gradient adjustment during erection of the upper section pillar ((n+1)th section pillar).

In the present embodiment, the tilt angles and the temperature are measured in parallel by the sensor devices 18ᵢ. However, the temperature measurement may be performed in parallel with measurement of the tilt angles of the target pillar 100ₚ by the sensor devices 18ᵢ using a temperature sensor different from the sensor device.

It has been known that the tilt angles and the like of a steel frame pillar are relevant to physical quantities other than the temperature, for example, “wind power (k)”, “a load (w) from above”, “ground vibration (g)”, and the like.

Hence, a function having at least one of the temperature (t), the wind power (k), the load (w) from above, and the ground vibration (g) as a parameter can also be used instead of f(t). For example, a function having all the wind power (k), the load (w) from above, and the ground vibration (g), in addition to the temperature (t), as parameters can be expressed as f(t, k, w, g). A function having such a form may be obtained by simulation or the like.

Thus far, a case in which the steel frame of the n(≥2)th section (nth section pillar) is the target pillar 100ₚ has been described. However, the first section pillar may be a target pillar, and measurement of the tilt angles, the temperature, and the like may be performed similarly to the target pillar 100ₚ described above with respect to the target pillar (first section pillar) using the sensor devices 18ᵢ.

In this case, as necessary, the offset with respect to the erection target position for the pillar head of the second section pillar can be set similarly as described above using the measurement data of the sensor devices with respect to the first section pillar.

The processing (including computation) of output data of the sensor devices 18ᵢ and the three-dimensional surveying instruments 30ⱼ related to measurement which has been described so far is performed by the server 12, and the information necessary for adjustment of the erection adjustment jigs 50 is provided to the mobile terminal 16 carried by an on-site worker from the server 12 in response to an inquiry. That is, in the present embodiment, it is also possible to consider that the measurement system 10 constitutes a steel frame erection adjustment system based on the measurement results of the tilt angles of the steel frame including work of adjusting the erection adjustment jigs by an on-site worker as a part thereof. At least a part of the functions of the server 12 may be given to the site side computer 14.

As described above, according to the present embodiment, as shown in FIG. 6(A), parallel measurement of the tilt angles at the measurement points at the same height positions in the target pillar 100 is performed by the three-dimensional surveying instrument 30ⱼ and the sensor devices 18ᵢ in each of the sensor devices 18ᵢ (i=1 to 6) (Step S104), and the calibration information described above is obtained in each of the sensor devices through computation using results of the parallel measurement (Step S106). When the origin of each of the sensor devices 18ᵢ is reset using this calibration information, thereafter, every time measurement of the tilt angles is performed at predetermined measurement points in the target pillar by the sensor devices 18ᵢ, measurement data which is substantially the same as that in measurement of the tilt angles at the predetermined measurement points in the target pillar using the three-dimensional surveying instrument 30ⱼ will be obtained. However, the origins of the sensor devices 18ᵢ do not necessarily need to be reset. After the calibration information is acquired, every time measurement of the tilt angles at the predetermined measurement points in the target pillar is performed by the sensor devices 18ᵢ, using the calibration information together with the measurement information by the sensor devices, measurement data which is substantially the same as measurement of the tilt angles at the predetermined measurement points in the target pillar is obtained using the three-dimensional surveying instrument 30ⱼ.

For this reason, since the calibration information (or correction information) is acquired once in the stage of positional adjustment after temporary fixing (including misalignment adjustment and gradient adjustment) for each of the steel frame pillars, it becomes favorable by simply using the three-dimensional surveying instrument 30ⱼ constituted of a total station or the like for parallel measurement with the sensor devices. As a result, it is no longer required to perform surveying work a plurality of times thereafter using a surveying instrument such as a total station in a stage of remeasurement after beam insertion, a stage of final tightening of the pillar couplers, a stage of welding of pillars in upper and lower sections, and the like.

In addition, in a stage of remeasurement after beam insertion, a stage of final tightening of the pillar couplers, a stage of welding of pillars, and the like, measurement of the tilt angles at the predetermined measurement points in the target pillar is performed by the sensor devices 18ᵢ, but this measurement data of the tilt angles scarcely includes a measurement error caused by measurement repeatedly performed a plurality of times. The reason is that since the sensor devices remain fixed at predetermined attachment positions in the pillar, measurement errors caused by positional deviations of the sensor devices do not occur even if measurement is repeatedly performed. In addition, since the sensor devices always measure the amount of fluctuation in the tilt angles from a reference time at any point of time, if the point of time of parallel measurement with the three-dimensional surveying instrument 30ⱼ described above is adopted as a reference point of time, by using the calibration information described above calculated using the measurement results of the sensor devices and the three-dimensional surveying instrument at this reference time, it is possible to obtain results of erection measurement substantially equivalent to those in the case of erection measurement using a surveying instrument such as a total station, for each of the steel frame pillars.

In addition, as described earlier, the present embodiment employs various techniques for setting an offset using the measurement data measured in real time during erection of the upper section pillar or immediately before erection of the upper section pillar using the sensor devices, or measurement data measured throughout a predetermined time after welding. Therefore, it can be said that an offset set by these setting techniques is an offset set on the basis of information which more accurately reflects the actual positional deviation of the pillar head of the lower section pillar during erection of the upper section pillar, compared to the offsets in the related art. The reason is that an offset of an erection position of an upper section pillar has been set in the related art based on reliance on the measurement results of the tilt angles of the lower section pillar measured only once after welding using a surveying instrument such as a total station.

In the foregoing embodiment, a case in which pillar misalignment adjustment, gradient adjustment, level adjustment, and the like are performed using the erection adjustment jigs 50 has been described. However, it is not limited to this, and an erection method that has been employed in the related art, in which wires are adjusted with lever blocks (registered trademark) or turn-buckles to make pillars perpendicular after pillars and beams are fastened with temporary bolts and anchor bolts are loosened slightly, may be employed. Even in this case, final tightening of bolts, in which the erection pieces are sandwiched between splice plates and tightened with high-strength bolts after perpendicular positioning, welding, and the like are performed, and therefore the erection measurement according to the foregoing embodiment (FIGS. 5 and 6(A) to 6(C)) can be applied.

In the foregoing embodiment, as an example of a structure under construction, erection of a steel frame structure that is a kind of architectural structure is handled, and a case in which the measurement method according to the present invention is applied to erection measurement using the measurement system 10 having a plurality of sensor devices 18ᵢ and a plurality of three-dimensional surveying instruments 30ⱼ has been described. However, it is not limited to erection of a steel frame structure, and the measurement method according to the foregoing embodiment can be performed for a structural material of an architectural structure (structure) being built (under construction) as an object. For example, a ceiling, a roof, and the like can also become an object. A structure set as a target of the measurement method according to the present invention is not limited to a building, and it may be a viaduct, a bridge, a dam, a tunnel, a stadium, a hall, and the like. In short, the measurement method according to the present invention can be applied to all structures in which three-dimensional surveying instruments are used for construction (building). An object is not limited to a structure, and it may be an earth retaining wall, a slope, and the like.

In addition, even in a completed architectural structure (structure), the measurement method according to the foregoing embodiment can be performed for a part thereof, for example, a construction material (structural material) such as a pillar, a wall, a ceiling, or a roof set as an object. In this case as well, it is not limited to a building, and a part of a structure such as a viaduct, a bridge, a dam, a tunnel, a stadium, or a hall may be set as an object, or an earth retaining wall, a slope, or the like may be set as an object.

In addition, in the foregoing embodiment, a case of obtaining the calibration information of the measurement information of the sensor devices 18ᵢ for causing second positional information to match first positional information on the basis of the measurement results of the information of the tilt angles (first positional information) at the measurement points in the pillar that is a structural material measured by the three-dimensional surveying instruments 30ⱼ and the information of the tilt angles (second positional information) at the measurement points in the pillar that is measured by the sensor devices 18ᵢ has been described. However, the calibration information of the measurement information of the sensor devices 18ᵢ is not limited to the calibration information for causing the second positional information to match the first positional information. The calibration information need only be information indicating a certain relationship between the positional information measured by the sensor devices and the positional information measured by the three-dimensional surveying instruments, and the calibration information may be a coefficient indicating a relationship between the first positional information measured by the three-dimensional surveying instruments and the second positional information measured by the sensor devices. It is sufficient if the positional information after correction can be brought closer to the positional information measured by the three-dimensional surveying instruments by correcting the second positional information measured by the sensor devices using the calibration information.

In addition, in the foregoing embodiment, in Step S104, the tilt angles at the measurement points at the same height positions in the target pillar 100 are measured using the sensor devices 18ᵢ and the three-dimensional surveying instruments 30ⱼ, but the measurement points of the sensor devices 18₁ and the three-dimensional surveying instruments 30ⱼ do not necessarily have to be the same. In this case, the positional information (information of the tilt angles) at a plurality of points in the target pillar 100 may be measured using each of the sensor devices 18ᵢ and the three-dimensional surveying instruments 30ⱼ having measurement points different from each other, an approximation curve indicating a tilt of a target pillar (steel frame) may be calculated from the measurement results, and the calibration information of the measurement information of the sensor devices related to a height direction of the steel frame from the calculated approximation curve may be acquired. In more details, the positional information (information of the tilt angles) at each of a plurality of points at different positions related to the height direction on a predetermined surface (which will hereinafter be suitably referred to as a measurement surface) of the target pillar 100 using the three-dimensional surveying instruments 30ⱼ is measured. At the same time, the positional information (information of the tilt angles) at each of the plurality of points at different positions related to the height direction on the measurement surface of the target pillar 100 is measured using each of the plurality of sensor devices 18ᵢ which have been calibrated in advance such that the measurement values match each other. Further, a polynomial function f₁(z) having, as a parameter, a height z showing the approximation curve indicating a tilt at each point in the height direction on the measurement surface of the target pillar 100 is calculated through function fitting of the information of the tilt angles at each of the plurality of points measured using the three-dimensional surveying instruments 30ⱼ. At the same time, a polynomial function f₂(z) having, as a parameter, the height z showing the approximation curve indicating a tilt at each point in the height direction on the measurement surface of the target pillar 100 is calculated through function fitting of the information of the tilt angles at each of the plurality of points measured using the plurality of sensor devices 18ᵢ. Further, on the basis of the polynomial function f₁(z) and the polynomial function f₂(z), the calibration information for bringing the measurement information of the sensor devices 18ᵢ having each point in the height direction on the measurement surface of the target pillar 100 as the measurement point closer to the measurement information at the same height position on a predetermined surface of the target pillar 100 by the three-dimensional surveying instruments 30ⱼ may be acquired. In this case, the calibration information for causing the measurement information of an arbitrary sensor device 18ᵢ to substantially match the measurement information of the three-dimensional surveying instruments 30ⱼ is obtained from the difference between two pieces of information of the tilt angles obtained by individually substituting the values of the height z of the measurement points in the sensor devices 18ᵢ for the polynomial functions f₁(z) and f₂(z). Here, since the information of the tilt angles obtained by substituting the values of the height z of the measurement points in the sensor devices 18ᵢ for the polynomial function f₂(z) substantially matches the measurement information of the sensor devices 18ᵢ, it is sufficient to obtain the polynomial function f₁(z) in order to obtain the calibration information for causing the measurement information of an arbitrary sensor device 18ᵢ to substantially match the measurement information of the three-dimensional surveying instruments 30ⱼ. Therefore, the polynomial function f₂(z) does not necessarily have to be obtained.

In the foregoing description, as a precondition for calculation of the polynomial function f₂(z), the positional information (information of the tilt angles) at each of the plurality of points at different positions related to the height direction on the measurement surface of the target pillar 100 is measured using the plurality of sensor devices 18ᵢ which have been calibrated in advance such that the measurement values match each other, but the positional information (information of the tilt angles) at each of the plurality of points at different positions related to the height direction on the predetermined surface of the target pillar 100 may be measured by moving a single sensor device 18ᵢ.

As is clear from the foregoing description using a polynomial function related to acquisition of calibration information, the calibration information may be information including a function.

In addition, in description so far, a case in which three sensor devices 18 are disposed in the upward-downward direction on the measurement surface has been described. However, it is also possible to consider that the sensor devices 18₁ are disposed two-dimensionally on the measurement surface. Particularly, when the measurement surface of an object is a three-dimensionally curved surface, the sensor devices may be disposed two-dimensionally on the measurement surface. However, since the sensor devices 18ᵢ actually output the tilt angles of the normal vectors (three-dimensional tilt angles) on the measurement surface, the shape of the measurement surface of an object (surface shape) can also be derived from the measurement point coordinates and the measurement value of the normal vector. For example, the shape may be calculated by obtaining the surface slope of each of the measurement points and the height of each of the measurement points with respect to the reference surface (the shift amount, the amount of lateral deviation) from the first-order integral thereof, or the shape of an object may be obtained on the basis of a function obtained by changing the function subjected to fitting to data of a tilt distribution obtained from a plurality of pieces of data regarding the same object obtained through measurement into an integral system. For example, a function such as a differential Zernike can be used as the fitting function. The shape may be calculated using coordinates of a finite number of discrete measurement points on the measurement surface of an object and actually measured values of the normal vector by optimizing the order and the coefficients of an approximated surface indicated by a Fourier series expansion, for example, such that errors at the respective measurement points are minimized. Further, various methods using various functions can be used as long as the shape can be calculated using the tilt angles at a plurality of measurement points. Even when the shape of the measurement surface is obtained using the three-dimensional surveying instruments 30ⱼ, the shape of the measurement surface can be obtained in a similar manner using the positional information obtained at each of the measurement points by two-dimensionally disposing the measurement points on a plurality of measurement surfaces similarly to the case of the sensor devices 18ᵢ.

That is, the information calculated from the positional information measured by the sensor devices is not limited to a tilt of a pillar (one-dimensional tilt information) and may be two-dimensional information such as a surface shape.

In the foregoing embodiment, mapping of the measurement information of the three-dimensional surveying instruments and the sensor devices is performed based on the tilt angles. However, the amount of lateral deviation (shift amount) may be obtained from the tilt angle obtained at each of the measurement points, and the calibration information may be calculated and managed using this shift amount.

The server 12 constituting the measurement system 10 may be under management of a user of the sensor devices in a construction company or the like. Alternatively, when the sensor devices are leased (or rented) from a supplying company (a maker, a supplier, or the like) to a construction company, the server 12 may be under management of the supplying company.

### REFERENCE SIGNS LIST

18ᵢ (18₁, 18₂, 18₃, 18₄, 18₅, 18₆) Sensor device
30ⱼ (30₁, 30₂) Three-dimensional surveying instrument
100ₚ Pillar

1. A measurement method for a structural material of a structure as an object, the measurement method comprising:
measuring positional information of the structural material using a three-dimensional surveying instrument and a sensor device attached to the structural material, respectively; and
acquiring calibration information for calibrating measurement information of the sensor device on the basis of measurement results of the positional information from both the three-dimensional surveying instrument and the sensor device.

2. The measurement method according to claim 1 further comprising:
after the calibration information is acquired, measuring positional information of the structural material using information measured by the sensor device and the calibration information.

3. The measurement method according to claim 2,
wherein the positional information is measured at a plurality of points, and shape information of the structural material is obtained using the measurement results.

4. The measurement method according to claim 3,
wherein the sensor device used for measuring the positional information includes a sensor for measuring angular information.

5. The measurement method according to claim 4,
wherein the sensor measures an angle, with respect to, as a reference, a direction of gravity, as the angular information.

6. The measurement method according to claim 4,
wherein a lateral deviation of measurement points of the sensor device is obtained from the angular information, and the shape information of the structural material is acquired using the obtained lateral deviation.

7. The measurement method according to claim 1,
wherein in the measuring, positional information of the structural material at a plurality of points is measured by each of the three-dimensional surveying instrument and the sensor device, and
in the acquiring, the calibration information is acquired on the basis of the positional information of the structural material at the plurality of points measured by each of the three-dimensional surveying instrument and the sensor device.

8. The measurement method according to claim 1,
wherein in the measuring, positional information at measurement points set in the structural material is measured by each of the three-dimensional surveying instrument and the sensor device, and
in the acquiring, the calibration information is acquired on the basis of the positional information at the measurement points measured by each of the three-dimensional surveying instrument and the sensor device.

9. The measurement method according to claim 7,
wherein the positional information of the structural material is measured by the sensor device after the calibration information is acquired, and positional information obtained by substantially calibrating the measured positional information based on the calibration information is used as the measurement results.

10. The measurement method according to claim 1,
wherein the positional information measured by the sensor device includes information of a tilt angle, which is with respect to, as a reference, a direction of gravity of the structural material.

11. The measurement method according to claim 1,
wherein a structural material of a completed structure is set as the object.

12. The measurement method according to claim 1,
wherein a structural material of a structure under construction is set as the object.

13. A method for constructing a structure utilizing the measurement method according to claim 12, the method comprising:
measuring information of a tilt angle at a predetermined measurement point in a pillar to be erected set as the object using the sensor device and the three-dimensional surveying instrument; and
acquiring the calibration information for causing information of a tilt angle measured by the sensor device to match information of a tilt angle measured by the three-dimensional surveying instrument on the basis of the measurement results.

14. The method for constructing a structure according to claim 13,
wherein information of the tilt angle is measured by the sensor device and the three-dimensional surveying instrument in parallel.

15. The method for constructing a structure according to claim 13 further comprising:
resetting an origin of the sensor device for causing a measurement origin of the sensor device to match a measurement origin of the three-dimensional surveying instrument using the calibration information after the calibration information is acquired,
wherein after the resetting of the origin, a tilt angle of the pillar is measured by the sensor device after the resetting of the origin.

16. The method for constructing a structure according to claim 13,
wherein the pillar to be erected is a pillar of an arbitrary section from a second section, and
information of the tilt angle for acquiring the calibration information is measured by the sensor device and the three-dimensional surveying instrument at an arbitrary timing during positional adjustment including misalignment adjustment and gradient adjustment for a pillar of the arbitrary section.

17. The method for constructing a structure according to claim 16,
wherein the structure is a steel frame structure using a steel frame as a structural material.

18. The method for constructing a structure according to claim 17,
wherein information of a tilt angle is measured by the sensor device for a pillar of the arbitrary section set as an object at least at one of times after the calibration information is acquired, during remeasurement after beam insertion, after final tightening of pillar couplers, and after welding of pillars.

19. A method for constructing a structure including pillars of a plurality of sections, the method comprising:
setting an offset, on the basis of information of a tilt angle at a measurement point in an erected measurement target pillar measured by a sensor device which is attached to the measurement target pillar during erection or immediately before erection of a pillar of an upper section on the measurement target pillar, to an erection target value for a pillar head of the pillar of the upper section.

20. A method for constructing a structure including pillars of a plurality of sections, the method comprising:
measuring a temperature t in parallel with measurement of information of a tilt angle of a measurement target pillar by a sensor device at predetermined sampling intervals over a predetermined time prior to erection of a pillar of an upper section on the measurement target pillar after welding of the measurement target pillar to which the sensor device is attached has ended;
obtaining a function f expressing information of the tilt angle acquired by the sensor device including the temperature t as a parameter on the basis of sampling data acquired through measurement; and
setting an offset to an erection target value for a pillar head of the pillar of the upper section on the basis of the function f in which a reference temperature T is substituted for the parameter t.

21. The method for constructing a structure according to claim 20,
wherein the sensor device has a temperature sensor, and
the temperature t is measured using the temperature sensor.
